(19) United States
(12) Patent Application Publication
(10) Pub. No.: US 2009/0252446 A1
(43) Pub. Date: Oct. 8, 2009

(54) Wheel rolling bearing assembly and manufacturing method thereof

(75) Inventors: Tatsuya YOKOTA, Toyota-shi (JP); Tatsuki MORI, Toyota-shi (JP); Nobuyuki SEO, Toyoake-shi (JP); Yoshito TAKADA, Nara-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: JTEKT CORPORATION, Osaka (JP)

(21) Appl. No.: 12/385,088

(22) Filed: Mar. 30, 2009

(30) Foreign Application Priority Data
Mar. 31, 2008 (JP) 2008-091971
Mar. 31, 2008 (JP) 2008-091972
Mar. 31, 2008 (JP) 2008-091973

(51) Int. Cl. F16C 43/04; B21D 53/10

(52) U.S. Cl. 384/510; 29/898.061

(57) ABSTRACT

A rolling bearing assembly for a wheel includes: an inner ring member in which an inner ring raceway surface is formed on an outer peripheral surface of the inner ring member; an outer ring member having a fitting tubular portion on the inboard side that is fitted into an attachment hole of a vehicle body member, and an outer ring raceway surface is formed on an inner peripheral surface of the outer ring member; a plurality of rolling elements disposed between the inner and outer ring raceway surfaces; and a cage that holds the plurality of rolling elements. The bore diameter B of the fitting tubular portion of the outer ring member is smaller than the diameter C of a circumscribed circle of the rolling elements.

### INCORPORATION BY REFERENCE

The disclosure of Japanese Patent Applications No. 2008-091971 filed on Mar. 31, 2008, No. 2008-091972 filed on Mar. 31, 2008 and No. 2008-091973 filed on Mar. 31, 2008 including the specification, drawings and abstract is incorporated herein by reference in its entirety.

### BACKGROUND OF THE INVENTION

1. Field of the Invention

The present invention relates to a rolling bearing assembly for wheel, and to a manufacturing method thereof.

2. Description of the Related Art

A type of a rolling bearing assembly for a wheel is described in, for example, Japanese Patent Application Publication No. 2001-12484 (JP-A-2001-12484). As shown in FIGS. 17 and 18, the rolling bearing assembly for a wheel includes an inner ring member ( wheel hub) 110 attached to a wheel, an outer ring member 120 fixed to a vehicle body side, a plurality of lines of rolling elements 132, 133, and cages 134, 135. An attachment flange 125 is formed on the outer peripheral surface of the outer ring member 120. A fitting tubular portion 126 which projects to be fitted into an attachment hole 104 of a vehicle body member (knuckle, carrier, etc.) 101 is formed at a portion of the outer ring member 120 which extends toward the vehicle inner side with respect to the attachment flange 125. The rolling bearing assembly for a wheel is attached to the vehicle body member 101 by fitting the fitting tubular portion 126 of the outer ring member 120 into the attachment hole 104 of the vehicle body member 101 and fastening the attachment flange 125 to the vehicle body member 101 with a bolt 105.

In the rolling bearing assembly for a wheel as shown in FIGS. 17 and 18, in assembling the plurality of rolling elements 133 and the cage 135 that holds the rolling elements 133 onto an outer ring raceway surface 122 of the outer ring member 120 positioned on the vehicle inner side, an assembly in which the rolling elements 133 are fitted into respective pockets of the cage 135 is inserted through an inner hole of the fitting tubular portion 126 of the outer ring member 120 until the assembly abuts on the outer ring raceway surface 122 of the outer ring member 120 positioned on the vehicle inner side, as shown in FIG. 18. Thus, defining the bore diameter of the fitting tubular portion 126 of the outer ring member 120 as A′ and the circumscribed circle diameter of the rolling elements 133 (132) (which is equivalent to the maximum diameter of the outer ring raceway surface) as B′, the relation A′≧B′ must be satisfied. Meanwhile, in order to increase the rigidity (improve the bearing performance), the circumscribed circle diameter B′ of the rolling elements 133 (132) may be increased and, accordingly, the number of the rolling elements 133 (132) may be increased or the diameter of the rolling elements 133 (132) may be increased. However, the outer diameter F′ of the fitting tubular portion 126 of the outer ring member 120 must correspond to the attachment hole 104 of the vehicle body member 101, and thus cannot be changed. That is to say, the bore diameter A′ cannot be increased because of the necessity to ensure the thickness of the fitting tubular portion 126 of the outer ring member 120. As a result, in the rolling bearing assembly for a wheel shown in FIG. 17, it is difficult to increase the circumscribed circle diameter B′ of the rolling elements 133 (132) to be larger than the bore diameter A′ of the fitting tubular member 126 in order to increase the rigidity.

### SUMMARY OF THE INVENTION

The present invention provides a rolling bearing assembly for a wheel in which the circumscribed circle diameter of rolling elements is increased to increase the rigidity without varying the outer diameter and the bore diameter of a fitting tubular portion of an outer ring member, and to provide a production method for the rolling bearing assembly.

An aspect of the present invention provides a rolling bearing assembly for a wheel including: an inner ring member attached to a wheel and having an inner ring raceway surface on an outer peripheral surface; an outer ring member having a fitting tubular portion at an inboard end portion of the outer ring member, whose the fitting tubular portion is fitted into an attachment hole of a vehicle body member, the outer ring member also having an outer ring raceway surface on an inner peripheral surface of the outer ring member; a plurality of rolling elements disposed between both the inner and outer ring raceway surfaces; and a cage that holds the plurality of rolling elements. A bore diameter B of the fitting tubular portion of the outer ring member is smaller a circumscribed circle diameter C of the rolling elements.

According to this aspect, the cage is inserted into the outer ring member, with the plurality of rolling elements arranged at regular intervals using a jig or the like on the outer ring raceway surface of the outer ring member, so that the plurality of rolling elements can be fitted in each pocket of the plurality of pockets of the cage, for assembly. Since the plurality of rolling elements and the cage is assembled onto the outer ring raceway surface of the outer ring member in this way, the circumscribed circle diameter C of the rolling elements can be set to be larger than the bore diameter B of the fitting tubular portion of the outer ring member. Then, the number of the rolling elements used can be increased or the diameter of the rolling elements can be increased for the increase in the circumscribed circle diameter C of the rolling elements. This increases the rigidity and improves the durability of the rolling bearing assembly for a wheel. In addition, the configuration also provides a weight reduction effect, because the weight of the outer ring member can be reduced for the increase in the circumscribed circle diameter C of the rolling elements, in other words, the maximum diameter of the outer ring raceway surface of the outer ring member.

In a rolling bearing assembly for a wheel in accordance with a first aspect which is based on the aforementioned aspect, a maximum outer diameter D of the cage is a bore diameter F of an outer ring shoulder portion, the outer ring shoulder portion that is formed on an outboard side of the outer ring member with respect to the outer ring raceway surface and that projects radially inward, a relation D≦F may be satisfied, and the cage may be inserted through the outer ring shoulder portion into the outer ring member from the outboard side of the vehicle, with the plurality of rolling elements arranged at regular intervals on the outer ring raceway surface, so that the rolling element is fitted into each pocket of a plurality of pockets of the cage.

According to the aforementioned first aspect, the maximum outer diameter D of the cage is configured to be the same as or smaller than the bore diameter F of the outer ring shoulder portion, which is formed on an outboard side of the outer ring member with respect to the outer ring raceway surface and that projects radially inward. Thus, the cage can be inserted through the outer ring shoulder portion into the outer ring member from the outboard side of the vehicle, with the plurality of rolling elements arranged at regular intervals using a jig or the like on the outer ring raceway surface of the outer ring member, so that the rolling element can be fitted into each pocket of the plurality of pockets of the cage, for assembly. Since the plurality of rolling elements and the cage can be assembled onto the outer ring raceway surface of the outer ring member in this way, the circumscribed circle diameter C of the rolling elements can be set to be larger than the bore diameter B of the fitting tubular portion of the outer ring member.

In a rolling bearing assembly for a wheel in accordance with a second aspect which is based on the aforementioned aspect, a maximum outer diameter D of the cage is smaller than or equal to the bore diameter B of the fitting tubular portion, and the cage may be inserted into the outer ring member from the inboard side of the vehicle, with the plurality of rolling elements arranged on the outer ring raceway surface of the outer ring member, so that the rolling element is fitted into each pocket of a plurality of pockets of the cage.

According to the aforementioned second aspect, the maximum outer diameter D of the cage is configured to be the same as or smaller than the bore diameter B of the fitting tubular portion of the outer ring member. Thus, the cage can be inserted from the inboard side of the vehicle, with the plurality of rolling elements arranged at regular intervals using a jig or the like on the outer ring raceway surface of the outer ring member, so that the rolling element can be fitted into each pocket of the plurality of pockets of the cage, for assembly. Since the plurality of rolling elements and the cage can be assembled onto the outer ring raceway surface of the outer ring member in this way, the circumscribed circle diameter C of the rolling elements can be set to be larger than the bore diameter B of the fitting tubular portion of the outer ring member.

In a rolling bearing assembly for a wheel in accordance with a third aspect which is based on the aforementioned aspect, the cage may be formed with a split portion by which the cage is elastically deformed to reduce its diameter, and the cage and the plurality of rolling elements may be inserted through the fitting tubular portion of the outer ring member, with rolling element fitted into each pocket of a plurality of pockets of the cage, and when the cage is deformed by the split portion to reduce its diameter, and the initial shape of the cage may be then restored so that the plurality of rolling elements are arranged on the outer ring raceway surface of the outer ring member.

According to the aforementioned third aspect, the cage can be inserted through the fitting tubular portion of the outer ring member, with rolling element fitted into each pocket of the plurality of pockets of the cage, by deforming the cage spirally to reduce its diameter. Then, the plurality of rolling elements and the cage can be assembled onto the outer ring raceway surface of the outer ring member by restoring the cage to its initial shape while arranging the plurality of rolling elements on the outer ring raceway surface of the outer ring member. Thus, the circumscribed circle diameter C of the rolling elements can be set to be larger than the bore diameter B of the fitting tubular portion of the outer ring member.

In a rolling bearing assembly for a wheel in accordance with a fourth aspect which is based on the aforementioned aspect, the cage may be formed by a plurality of split cages that are split in a circumferential direction, and the split cages may be sequentially inserted through the fitting tubular portion of the outer ring member, with rolling element fitted into each pocket of the split cages, so that the plurality of rolling elements are arranged on the outer ring raceway surface of the outer ring member.

According to the aforementioned fourth aspect, the rolling elements can be fitted into each pocket of the split cages, that are split into a plurality of pieces in the circumferential direction, and then the plurality of split cages can be sequentially inserted through the fitting tubular portion of the outer ring member so that the plurality of rolling elements and the plurality of split cages can be assembled onto the outer ring raceway surface of the outer ring member. Since the plurality of rolling elements and the plurality of split cages can be assembled onto the outer ring raceway surface of the outer ring member in this way, the circumscribed circle diameter C of the rolling elements can be set to be larger than the bore diameter B of the fitting tubular portion of the outer ring member.

In the rolling bearing assembly for a wheel in accordance with the aforementioned aspect, the outer ring raceway surface may be formed as a recess with a semicircular cross section in the inner peripheral surface of the outer ring member.

A method of manufacturing a wheel rolling bearing assembly in accordance with an aspect of the present invention includes: preparing an inner ring member that is attached to a wheel and having an inner ring raceway surface on an outer peripheral surface; preparing an outer ring member having a fitting tubular portion at an inboard end portion of the outer ring member, the fitting tubular portion being fitted into an attachment hole of a vehicle body member, the outer ring member also having an outer ring raceway surface on an inner peripheral surface, and outer ring raceway surface being formed by such a recess that a bore diameter B of the fitting tubular portion of the outer ring member is smaller than a circumscribed circle diameter C of a rolling elements; preparing a plurality of rolling elements disposed between both the inner and outer ring raceway surfaces so as to be rollable; preparing a cage that holds the plurality of rolling elements; assembling the plurality of rolling elements and the cage onto the outer ring raceway surface; inserting the inner ring member into the outer ring member, to which the plurality of rolling elements and the cage have been assembled; and calking an inboard end of the inserted inner ring member to fix the outer ring member and the inner ring member.

In the method of manufacturing a wheel rolling bearing assembly in accordance with a first aspect which is based on the aforementioned aspect, the outer ring member may have an outer ring shoulder portion that is formed on an outboard side of the outer ring member with respect to the outer ring raceway surface and that projects radially inward, and a maximum outer diameter D of the cage is less than or equal to a bore diameter F of the outer ring shoulder portion, and the method may further include: holding the plurality of rolling elements at regular intervals on the outer ring raceway surface; inserting the cage through the outer ring shoulder portion into the outer ring member from the outboard side of the vehicle; and fitting rolling element into each pocket of a plurality of pockets of the cage.

In the method of manufacturing a wheel rolling bearing assembly in accordance with a second aspect which is based on the aforementioned aspect, the fitting tubular portion of the outer ring member may be formed such that a maximum outer diameter D of the cage is less than or equal to the bore diameter B of the fitting tubular portion, and the method may further include: holding the plurality of rolling elements such that the plurality of rolling elements is arranged on the outer ring raceway surface of the outer ring member; inserting the cage into the outer ring member from the inboard side of the vehicle; and fitting rolling element into each pocket of a plurality of pockets of the cage.

In the method of manufacturing a wheel rolling bearing assembly in accordance with a third aspect which is based on the aforementioned aspect, the cage may be formed with a split portion by which the cage is elastically deformed to reduce its diameter, and the method may further include: fitting rolling element into each pocket of a plurality of pockets of the cage; inserting the cage and the plurality of rolling elements through the fitting tubular portion; and restoring the cage to its initial shape after insertion through the fitting tubular portion so that the plurality of rolling elements are arranged on the outer ring raceway surface of the outer ring member.

In the method of manufacturing a wheel rolling bearing assembly in accordance with a fourth aspect which is based on the aforementioned aspect, the cage may include a plurality of split cages that are split in a circumferential direction, and the method may further include: fitting rolling element into each pocket of a plurality of pockets of the split cages; and sequentially inserting the split cages through the fitting tubular portion, with the plurality of rolling elements fitted in the split cages, so that the plurality of rolling elements are arranged on the outer ring raceway surface of the outer ring member.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a vertical cross sectional view showing a rolling bearing assembly for a wheel in accordance with a first embodiment of the present invention;

FIG. 2 is a vertical cross sectional view of the first embodiment showing an inner ring member, an outer ring member, rolling elements and cages in the assembly state as enlarged;

FIG. 3 is an illustration of the first embodiment showing the state after rolling elements are disposed on an outer ring raceway surface positioned on the inboard side of the outer ring member and before assembling a cage;

FIG. 4 is an illustration of the first embodiment showing the state after rolling elements and a cage are disposed on the outer ring raceway surface on the inboard side of the outer ring member positioned and subsequently rolling elements and a cage are disposed on an outer ring raceway surface positioned on the outboard side of the outer ring member;

FIG. 5 is an illustration of the first embodiment showing the state in which the inner ring member and the outer ring member are fitted and before an inner ring element is press-fitted onto a hub spindle of the inner ring member;

FIG. 6 is an illustration of the first embodiment showing the state in which a tubular portion provided at the tip of the hub spindle of the inner ring member is calked;

FIG. 7 is a vertical cross sectional view of a second embodiment showing an inner ring member, an outer ring member, rolling elements and cages in the assembly state as enlarged;

FIG. 8 is an illustration of the second embodiment showing the state after rolling elements are arranged on an outer ring raceway surface positioned on the inboard side of the outer ring member and before assembling a cage;

FIG. 9 is an illustration of the second embodiment showing the state in which the inner ring member and the outer ring member are fitted and before an inner ring element is press-fitted onto a hub spindle of the inner ring member;

FIG. 10 is an illustration of the second embodiment showing the state in which a tubular portion provided at the tip of the hub spindle of the inner ring member is calked;

FIG. 11 is a front view showing a cage for use in a third embodiment;

FIG. 12 is a perspective view of the third embodiment showing the state in which the cage is deformed spirally so as to reduce its diameter;

FIG. 13 is an illustration of the third embodiment showing the state in which the cage which has been deformed spirally so as to reduce its diameter is assembled onto an outer ring raceway surface positioned on the inboard side of the outer ring member;

FIG. 14 is a front view showing a plurality of split cages constructing a cage of a rolling bearing assembly for a vehicle in accordance with a fourth embodiment;

FIG. 15 is a perspective view of the fourth embodiment showing the plurality of split cages;

FIG. 16 is an illustration of the fourth embodiment showing the state in which the plurality of split cages are assembled onto an outer ring raceway surface on the inboard side of the outer ring member positioned;

FIG. 17 is a vertical cross sectional view showing a rolling bearing assembly for a wheel in accordance with a related art; and

FIG. 18 is an illustration of the related art showing the state before rolling elements and a cage are disposed on an outer ring raceway surface positioned on the inboard side of the outer ring member.

### DETAILED DESCRIPTION OF EMBODIMENTS

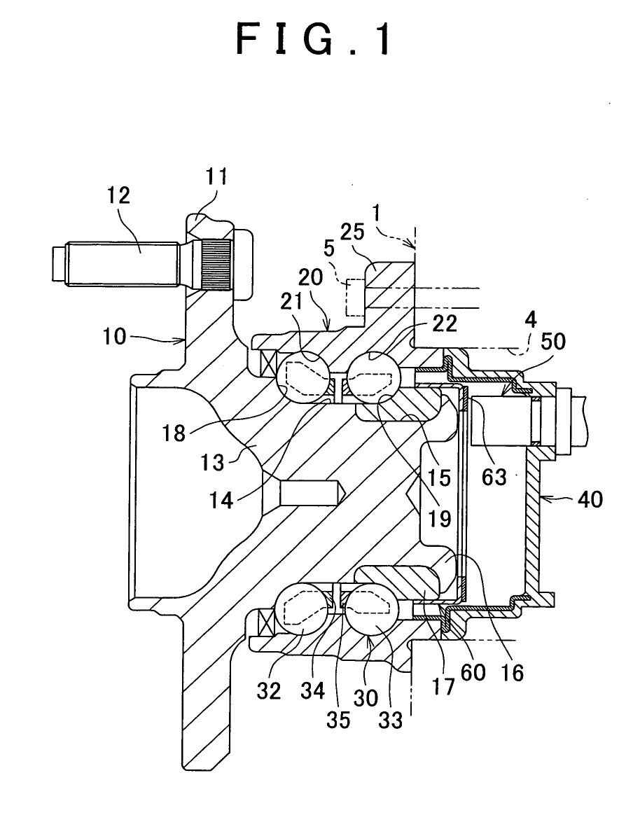

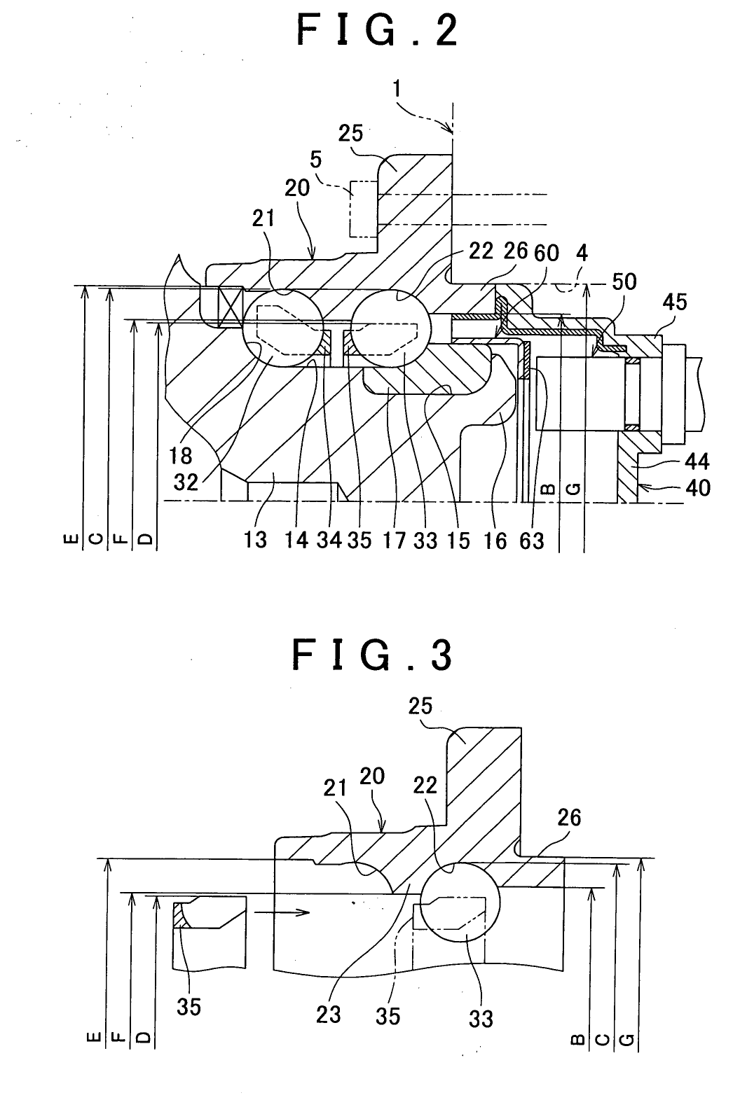

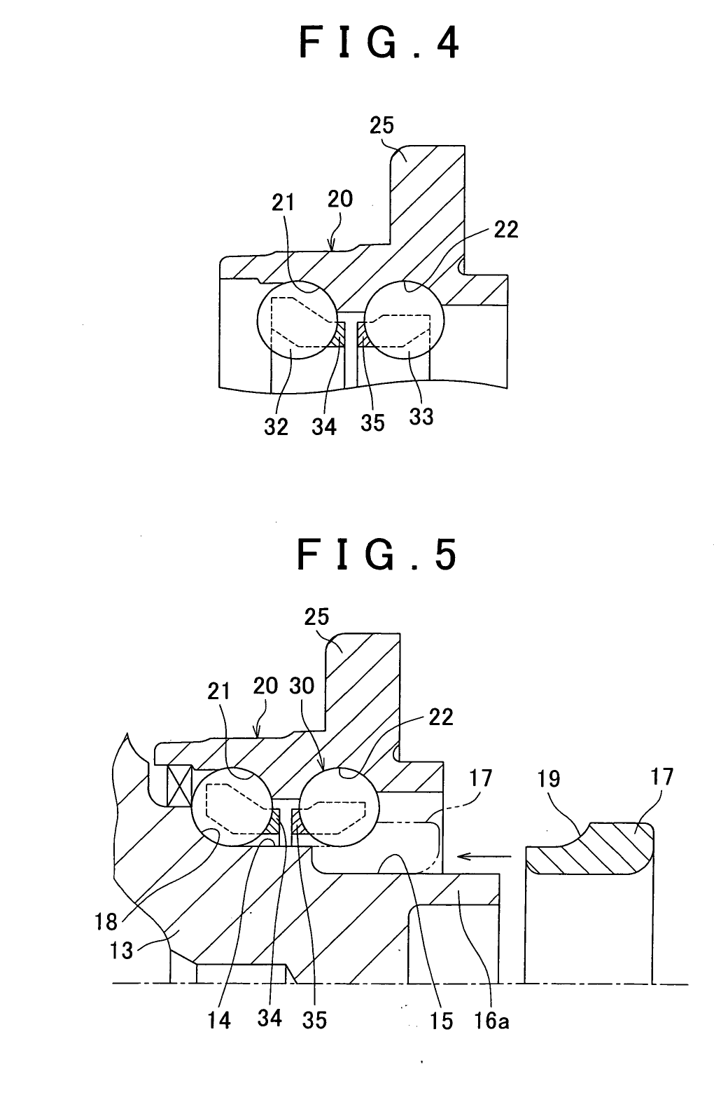

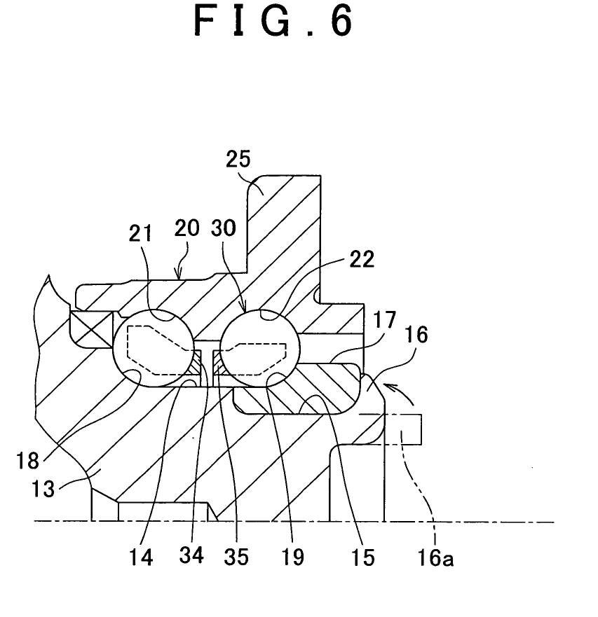

A first embodiment of the present invention will be described with reference to FIGS. 1 to 6. FIG. 1 is a vertical cross sectional view showing a rolling bearing assembly for a wheel in accordance with a first embodiment of the present invention. FIG. 2 is a vertical cross sectional view of the first embodiment showing an inner ring member, an outer ring member, rolling elements and cages in the assembly state as enlarged. FIG. 3 is an illustration of the first embodiment showing the state after rolling elements are disposed on an outer ring raceway surface positioned on the inboard side of the outer ring member and before assembling a cage. FIG. 4 is an illustration of the first embodiment showing the state after rolling elements and a cage are disposed on the outer ring raceway surface positioned on the inboard side of the outer ring member and subsequently rolling elements and a cage are disposed on an outer ring raceway surface positioned on the outboard side of the outer ring member. FIG. 5 is an illustration of the first embodiment showing the state in which the inner ring member and the outer ring member are fitted and before an inner ring element is press-fitted onto a hub spindle of the inner ring member. FIG. 6 is an illustration of the first embodiment showing the state in which a tubular portion provided at the tip of the hub spindle of the inner ring member is calked. In FIGS. 1 to 6, the left side corresponds to the outer side in the vehicle width direction, and the right side corresponds to the inner side in the vehicle width direction. Thus, in the description below, the direction corresponding to the left side of FIGS. 1 to 6 is referred to as “outboard side”, and the direction corresponding to the right side of FIGS. 1 to 6 is referred to as “inboard side”.

As shown in FIG. 1, a rolling bearing assembly for a wheel (a hub unit for a wheel) includes, as unitized, an inner ring member (wheel hub) 10 attached to a wheel, an outer ring member 20 fixed to a vehicle body, a plurality of lines of rolling elements (balls) 32, 33, cages 34, 35, a cover member 40, a rotation detector 50, and a tubular member 60 having a pulser ring 63.

As shown in FIGS. 1 and 2, the inner ring member 10 integrally includes a hub spindle 13 and a flange 11 formed on the outer peripheral surface of the hub spindle 13 close to an end on the outboard side of the inner ring member 10. A plurality of hub bolts 12 are press-fitted into the flange 11 on a circle, spaced at predetermined pitches or by predetermined angles from each other, to attach a wheel (driven wheel) with a brake rotor interposed therebetween. The inner ring member 10 also integrally includes a large-diameter shaft portion 14 formed at a portion of the hub spindle 13 on the inboard side of the hub spindle 13 with respect to the flange 11, and a small-diameter shaft portion 15, with a diameter suitably smaller than the diameter of the large-diameter shaft portion 14, positioned on the inboard side from the large-diameter shaft portion 14 with respect to the large-diameter shaft portion 14 and formed continuously next to the large-diameter shaft portion 14 with a stepped portion interposed therebetween. An inner ring raceway surface 18, positioned on the outboard side of the hub spindle 13, is formed on the outer peripheral surface of the large-diameter shaft portion 14. An inner ring element 17 is press-fitted onto the outer peripheral surface of the small-diameter shaft portion 15 of the hub spindle 13. An inner ring raceway surface 19, positioned on the inboard side, is formed on the outer peripheral surface of the inner ring element 17. A tubular portion 16a, which is an end of the small-diameter shaft portion 15 on the inboard side of the hub spindle 13, is calked to form a calked portion 16 so that the inner ring element 17 is fixed between the stepped portion and the calked portion 16 (see FIG. 6).

As shown in FIG. 1, the outer ring member 20 is formed in a tubular shape and disposed coaxially around the outer periphery of the hub spindle 13. Both outer ring raceway surfaces 21, 22 are formed to be dented on the inner peripheral surface of the outer ring member 20 so as to face both the inner ring raceway surfaces 18, 19, respectively, of the inner ring member 10. A plurality of rolling elements 32, 33 and synthetic-resin crown-like (single-sided) cages 34, 35 that hold the plurality of rolling elements 32, 33, respectively, are assembled between the inner and outer ring raceway surfaces 18, 19, 21, 22, respectively, to construct a plurality of lines of roller bearings (angular ball bearings) 30. The outer ring raceway surface 22, positioned on the inboard side of the outer ring member 20, is formed by forming a recess that is semicircular in cross section continuously along the inner peripheral surface of the outer ring member 20. An outer ring shoulder portion 23 is formed adjacently on the outboard side with respect to the outer ring raceway surface 22 that is positioned on the inboard side of the outer ring member 20. The outer ring shoulder portion 23 projects radially inward from the inner peripheral surface of the outer ring member 20 and forms a part of the outer ring raceway surface 22. The outer ring raceway surface 21, positioned on the outboard side of the outer ring member 20, is positioned adjacently on the outboard side with respect to the outer ring shoulder portion 23, and formed by forming a recess that is arc in cross section on a surface on the outboard side with respect to the outer ring shoulder portion 23. The cages 34, 35 in the first embodiment are in a continuous annular shape with no break as viewed in the axial direction of the rolling bearing assembly for a wheel.

As shown in FIG. 2, an attachment flange 25 is formed on the outer peripheral surface of the outer ring member 20 close to an end on the inboard side of the outer ring member 20. A fitting tubular portion 26 which projects to be fitted into an attachment hole 4 of a vehicle body member (knuckle, carrier, etc.) 1 is formed at an inboard end of the outer ring member 20 (at a portion of the outer ring member 20 on the inboard side with respect to the attachment flange 25). A cover member 40 in a lidded tubular shape is press-fitted into the inner peripheral surface of the fitting tubular portion 26 of the outer ring member 20 to protect the inside of the roller bearing 30 from muddy water and dust. A boss 45 is formed integrally in a lid 44 of the cover member 40 as a hole conforming to the outer peripheral shape of the rotation detector 50. The rotation detector 50 is fitted into the boss 45 for attachment. Meanwhile, the tubular member 60 having the pulser ring 63 at a position facing a detection portion of the rotation detector 50 is press-fitted onto the outer peripheral surface of the inner ring element 17 for attachment. The rolling bearing assembly for a wheel is thus unitized. The rolling bearing assembly for a wheel can be attached to the vehicle body member 1 by fitting the fitting tubular portion 26 of the outer ring member 20 into the attachment hole 4 of the vehicle body member 1 and fastening the attachment flange 25 to the vehicle body member 1 with a bolt 5.

In order to increase the rigidity (improve the bearing performance) of the rolling bearing assembly for a wheel, the circumscribed circle diameter C of the rolling elements 33 (32) (the maximum diameter of the outer ring raceway surface) is set to be larger than the bore diameter B of the fitting tubular portion 26 of the outer ring member 20. In order to allow the rolling elements 33 and the cage 35 to be disposed on the outer ring raceway surface 22 positioned on the inboard side of the outer ring member 20, the maximum outer diameter D of the cage 35 for use on the outer ring raceway surface 22 positioned on the inboard side is set to be the same as or slightly smaller than the bore diameter F of the outer ring shoulder portion 23 which is formed at a portion of the outer ring member 20 positioned on the outboard side with respect to the outer ring raceway surface 22 and formed to project radially inwardly between both the outer ring raceway surfaces 21, 22. That is, the relations “B<C” and “D≦F” are satisfied. The bore diameter E at an tip end on the outboard side of the outer ring member 20, which is on the opposite side of the fitting tubular portion 26 in the vehicle width direction, is set to be larger than the circumscribed circle diameter C of the rolling elements 32 (33). The outer diameter G of the fitting tubular portion 26 of the outer ring member 20 is formed to be approximately the same as the bore diameter of the attachment hole 4 of the vehicle body member 1.

The rolling bearing assembly for a wheel in accordance with the first embodiment is configured as discussed above. Thus, in assembling the plurality of lines of rolling elements 32, 33 and the cages 34, 35 between the inner ring member 10 and the outer ring member 20 to construct a unitized rolling bearing assembly for a wheel, first, the rolling elements 33 and the cage 35 are assembled onto the outer ring raceway surface 22 positioned on the inboard side of the outer ring member 20. At this time, as shown in FIG. 3, the plurality of rolling elements 33 are held at regular intervals using a jig or the like on the outer ring raceway surface 22 positioned on the inboard side of the outer ring member 20, and in this state the cage 35 is inserted from an opening of an inner hole provided at an outboard end on the outboard side of the outer ring member 20, which is on the opposite side of the fitting tubular portion 26 in the vehicle width direction. That is to say, the cage 35 is inserted into the opening of the inner hole of the outer ring member 20 from the outboard side of the vehicle. Then, after the cage 35 passes through the outer ring shoulder portion 23, the plurality of rolling elements 33 are fitted into respective pockets of the cage 35.

Then, as shown in FIG. 4, the rolling elements 32 and the cage 34 are assembled onto the outer ring raceway surface 21 positioned on the outboard side of the outer ring member 20. At this time, since the bore diameter E at an end on the outboard side of the outer ring member 20, is set to be larger than the circumscribed circle diameter C of the rolling elements 32 (33), an assembly in which the rolling elements 32 have been fitted in respective pockets of the cage 34 is inserted from an outboard opening of the outer ring member 20 to be assembled onto the outer ring raceway surface 21 positioned on the outboard side of the outer ring member 20.

Then, as shown in FIG. 5, the hub spindle 13 of the inner ring member 10 is fittingly inserted into the outer ring member 20. Here, the inner ring element 17 is press-fitted onto the small-diameter shaft portion 15 of the hub spindle 13. Then, as shown in FIG. 6, the tubular portion 16a at the tip of the small-diameter shaft portion 15 is calked using a calking jig to form the calked portion 16, allowing the outer ring member 20 and the inner ring member 10 to be integrated with the plurality of lines of roller bearings 30 interposed therebetween. Then, as shown in the drawing, the tubular member 60 having the pulser ring 63 is press-fitted onto the outer peripheral surface of the inner ring element 17 of the hub spindle 13 for fixation, and finally the cover member 40 having the rotation detector 50 is press-fitted into the inner peripheral surface of the fitting tubular portion 26 of the outer ring member 20 for fixation. A unitized rolling bearing assembly for a wheel is thus constructed.

As described above, the maximum outer diameter D of the cage 35 for use on the outer ring raceway surface 22 positioned on the inboard side of the outer ring member 20 is configured to be the same as or smaller than the bore diameter F of the outer ring shoulder portion 23. Thus, the cage 35 can be inserted through the opening of the inner hole of the outer ring member 20 on the opposite side of the fitting tubular portion 26 in the vehicle width direction, with the plurality of rolling elements 33 arranged at regular intervals using a jig or the like on the outer ring raceway surface 22 of the outer ring member 20 positioned on the inboard side, so that the plurality of rolling elements 33 can be fitted into the plurality of pockets of the cage 35 for assembly. Since the plurality of rolling elements 33 and the cage 35 can be assembled onto the outer ring raceway surface 22 positioned on the inboard side of the outer ring member 20 in this way, the circumscribed circle diameter C of the rolling elements 33 (32) can be set to be larger than the bore diameter B of the fitting tubular portion 26 of the outer ring member 20. Then, the number of the rolling elements 33 (32) used can be increased or the diameter of the rolling elements 33 (32) can be increased for the increase in the circumscribed circle diameter C of the rolling elements 33 (32). This increases the rigidity and improves the durability of the rolling bearing assembly for a wheel. In addition, the configuration also provides a weight reduction effect, because the weight of the outer ring member 20 can be reduced for the circumscribed circle diameter C of the rolling elements 33 (32), in other words, the maximum diameter of the outer ring raceway surface 22 (21) of the outer ring member 20, which is increased compared to the bore diameter B of the fitting tubular portion 26.

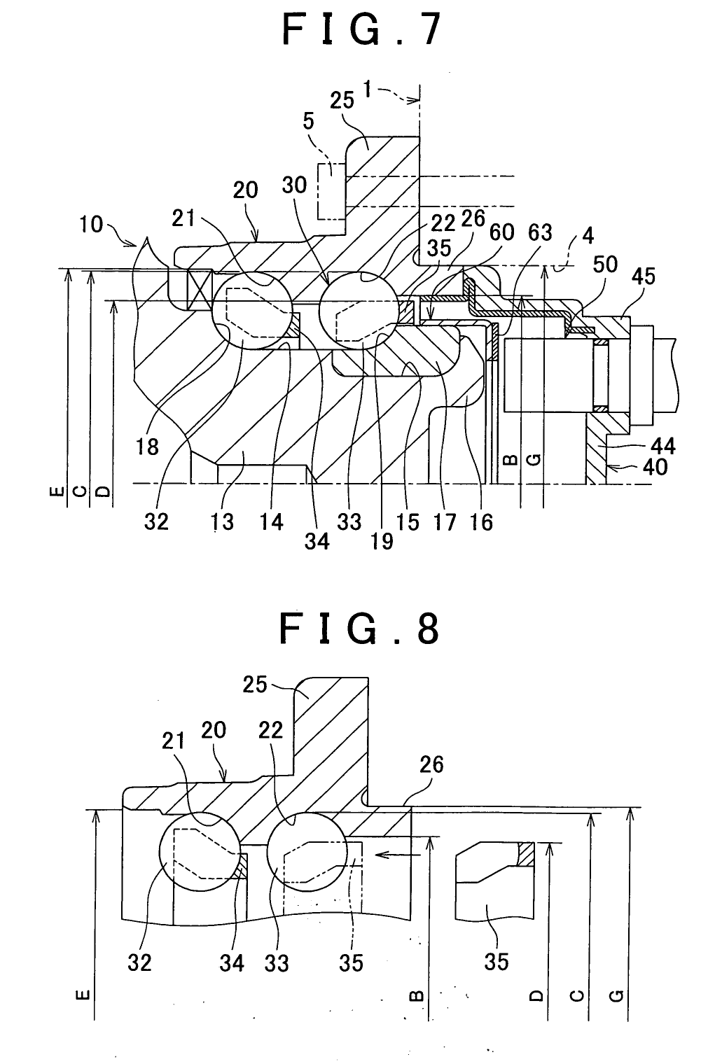

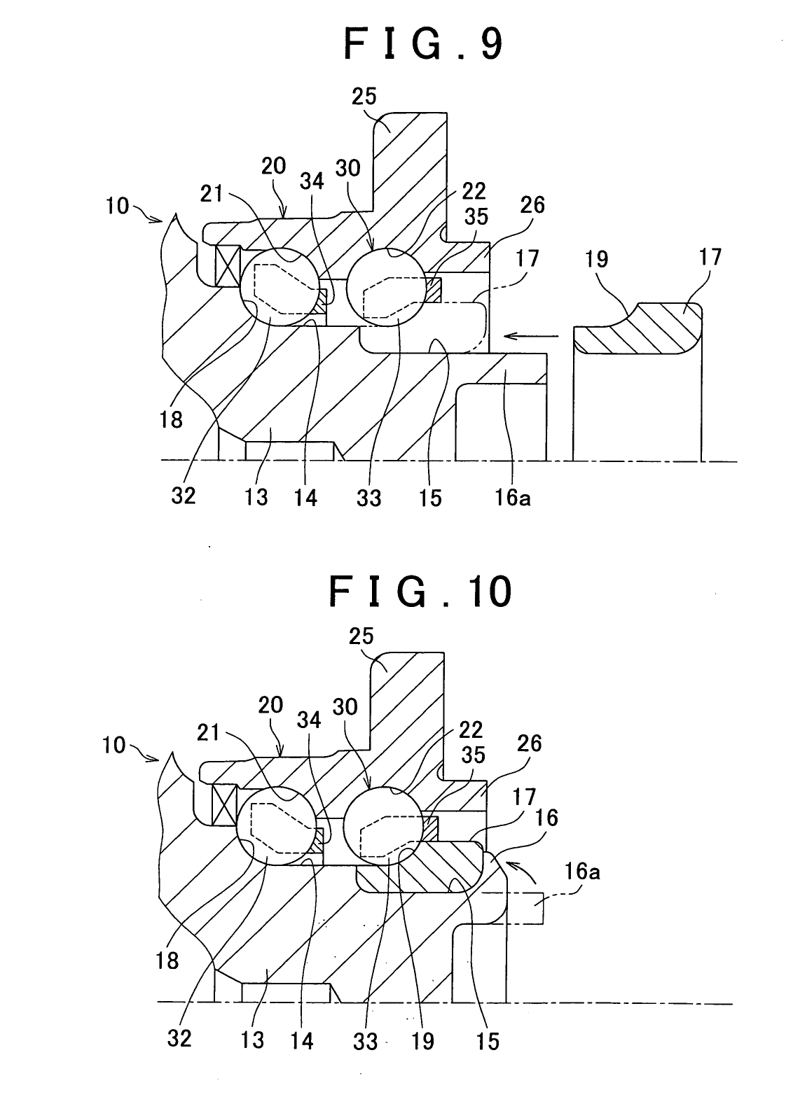

A second embodiment of the present invention will be described with reference to FIGS. 7 to 10. FIG. 7 is a vertical cross sectional view of the second embodiment showing an inner ring member, an outer ring member, rolling elements and cages in the assembly state as enlarged. FIG. 8 is an illustration of the second embodiment showing the state after rolling elements are disposed on an outer ring raceway surface positioned on the inboard side of the outer ring member and before assembling a cage. FIG. 9 is an illustration of the second embodiment showing the state in which the inner ring member and the outer ring member are fitted and before an inner ring element is press-fitted onto a hub spindle of the inner ring member. FIG. 10 is an illustration of the second embodiment showing the state in which a tubular portion provided at the tip of the hub spindle of the inner ring member is calked. In the second embodiment, the same components as those of the first embodiment are denoted by the same reference numerals as those of the first embodiment to omit their descriptions.

In the second embodiment, as shown in FIGS. 7 and 8, in order to increase the rigidity (improve the bearing performance) of the rolling bearing assembly for a wheel, the circumscribed circle diameter C of the rolling elements 33 (32) (the maximum diameter of the outer ring raceway surface) is set to be larger than the bore diameter B of the fitting tubular portion 26 of the outer ring member 20. In order to allow the rolling elements 33 and the cage 35 to be disposed on the outer ring raceway surface 22 positioned on the inboard side of the outer ring member 20, the maximum outer diameter D of the cage 35 for use on the outer ring raceway surface 22 positioned on the inboard side is set to be the same as or slightly smaller than the bore diameter B of the fitting tubular portion 26 of the outer ring member 20. That is, the relation “D≦B<C” is satisfied. The bore diameter E at an outboard end of the outer ring member 20, which is on the opposite side of the fitting tubular portion 26 in the axial direction, is set to be the same as or larger than the circumscribed circle diameter C of the rolling elements 32 (33). The outer diameter G of the fitting tubular portion 26 of the outer ring member 20 corresponds to the attachment hole 4 of the vehicle body member 1 (i.e. is set to be approximately the same as the bore diameter of the attachment hole 4).

The rolling bearing assembly for a wheel in accordance with the second embodiment is configured as discussed above. Thus, in assembling the plurality of lines of rolling elements 32, 33 and the cages 34, 35 between the inner ring member 10 and the outer ring member 20 to construct a unitized rolling bearing assembly for a wheel, first, the rolling elements 32, 33 and the cages 34, 35 are assembled onto both the outer ring raceway surfaces 21, 22, respectively, of the outer ring member 20. Since the bore diameter E of an outboard portion of the outer ring member 20 is set to be the same as or larger than the circumscribed circle diameter C of the rolling elements 32 (33), as shown in FIG. 8, an assembly in which the rolling elements 32 have been fitted in the respective pockets of the cage 34 for use on the outboard side is inserted from an opening on the outboard side of the outer ring member 20 to be assembled onto the outer ring raceway surface 21 positioned on the outboard side of the outer ring member 20. Meanwhile, the plurality of rolling elements 33 are held at regular intervals using a jig or the like on the outer ring raceway surface 22 positioned on the inboard side of the outer ring member 20, and in this state the cage 35 to be positioned on the inboard side is inserted through an inner hole of the fitting tubular portion 26 of the outer ring member 20 from the inboard side of the vehicle, so that the plurality of rolling elements 33 are fitted into the respective pockets of the cage 35 for assembly.

Then, as shown in FIG. 9, the hub spindle 13 of the inner ring member 10 is fittingly inserted into the outer ring member 20. Here, the inner ring element 17 is press-fitted onto the small-diameter shaft portion 15 of the hub spindle 13. Then, as shown in FIG. 10, the tubular portion 16a provided at the tip of the small-diameter shaft portion 15 is calked using a calking jig to form the calked portion 16, allowing the outer ring member 20 and the inner ring member 10 to be integrated with the plurality of lines of roller bearings 30 interposed therebetween. Then, as in the first embodiment shown in FIG. 1, the tubular member 60 having the pulser ring 63 is press-fitted onto the outer peripheral surface of the inner ring element 17 of the hub spindle 13 for fixation, and finally the cover member 40 having the rotation detector 50 is press-fitted into the inner peripheral surface of the fitting tubular portion 26 of the outer ring member 20 for fixation. A unitized rolling bearing assembly for a wheel is thus constructed.

As described above, the maximum outer diameter D of the cage 35 for use on the outer ring raceway surface 22 is configured to be the same as or smaller than the bore diameter B of the fitting tubular portion 26 of the outer ring member 20. Thus, the cage 35 can be inserted into the fitting tubular portion 26 of the outer ring member 20 from the inboard side of the vehicle, with the plurality of rolling elements 33 arranged at regular intervals using a jig or the like on the outer ring raceway surface 22 positioned on the inboard side of the outer ring member 20, so that the plurality of rolling elements 33 can be fitted into the plurality of pockets of the cage 35 for assembly. Since the plurality of rolling elements 33 and the cage 35 can be assembled onto the outer ring raceway surface 22 positioned on the inboard side of the outer ring member 20 in this way, the circumscribed circle diameter C of the rolling elements 33 (32) can be set to be larger than the bore diameter B of the fitting tubular portion 26 of the outer ring member 20. Then, the number of the rolling elements 33 (32) used can be increased or the diameter of the rolling elements 33 (32) can be increased for the increase in the circumscribed circle diameter C of the rolling elements 33 (32). This increases the rigidity and improves the durability of the rolling bearing assembly for a wheel. In addition, the configuration also provides a weight reduction effect, because the weight of the outer ring member 20 can be reduced for the increase in the circumscribed circle diameter C of the rolling elements 33 (32) (the maximum diameter of the outer ring raceway surface 22 (21)).

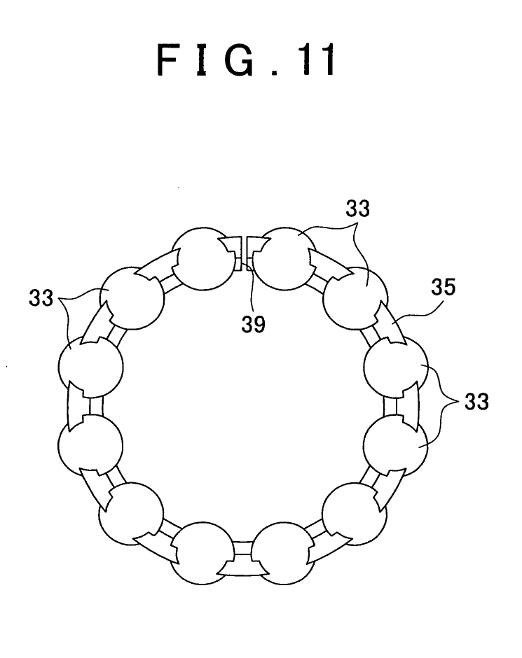

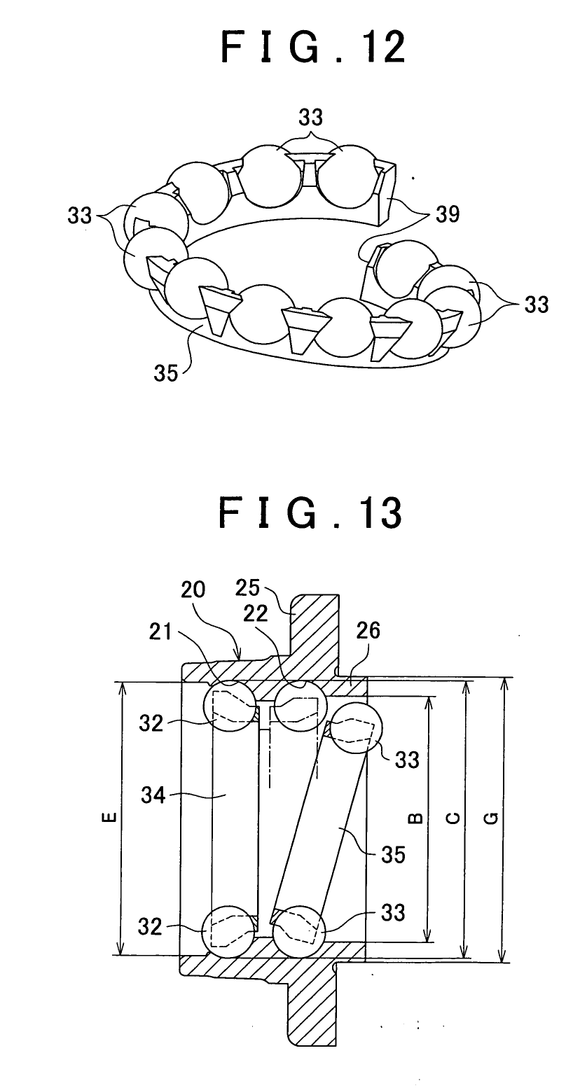

A third embodiment of the present invention will be described with reference to FIGS. 11 to 13. FIG. 11 is a front view showing a cage for use in a third embodiment. FIG. 12 is a perspective view of the third embodiment showing the state in which the cage is deformed spirally so as to reduce its diameter. FIG. 13 is an illustration of the third embodiment showing the state in which the cage which has been deformed spirally so as to reduce its diameter is assembled onto an outer ring raceway surface positioned on the inboard side of the outer ring member. In the third embodiment, the same components as those of the first and second embodiments are denoted by the same reference numerals to omit their descriptions.

In the third embodiment, as in the second embodiment, in order to increase the rigidity (improve the bearing performance) of the rolling bearing assembly for a wheel, the circumscribed circle diameter C of the rolling elements 33 (32) (the maximum diameter of the outer ring raceway surface) is set to be larger than the bore diameter B of the fitting tubular portion 26 of the outer ring member 20, as shown in FIG. 13. That is, the relation “B<C” is satisfied. In order to allow the rolling elements 33 and the cage 35 to be disposed on the outer ring raceway surface positioned on the inboard side 22 of the outer ring member 20, a split portion 39 is formed in the cage 35 for use on the outer ring raceway surface 22, as shown in FIGS. 11 and 12. The annular cage 35 is split at the split portion 39, by which the cage 35 can be deformed elastically and spirally so as to reduce its diameter. That is, the cage 35 can be inserted into the inner hole of the fitting tubular portion 26 while being deformed spirally so as to reduce its diameter, with the rolling elements 33 fitted and held in the respective pockets of the cage 35 for use on the outer ring raceway surface 22. The bore diameter E at an end on the outboard side of the outer ring member 20, which is on the opposite side of the fitting tubular portion 26 in the axial direction, is set to be larger than the circumscribed circle diameter C of the rolling elements 32 (33). The outer diameter G of the fitting tubular portion 26 of the outer ring member 20 is formed to be approximately the same as the bore diameter of the attachment hole 4 of the vehicle body member 1. The cage 34 is in a continuous annular shape with no split portion 39 as viewed in the axial direction of the rolling bearing assembly for a wheel.

The rolling bearing assembly for a wheel in accordance with the third embodiment is configured as discussed above. Thus, in assembling the plurality of lines of rolling elements 32, 33 and the cages 34, 35 between the inner ring member 10 and the outer ring member 20 to construct a unitized rolling bearing assembly for a wheel, first, the rolling elements 32 and the cage 34 are assembled, and the rolling elements 33 and the cage 35 are assembled, allowing the rolling elements 32, 33 to be held by the cages 34, 35, respectively. Then, the cages 34, 35 holding the rolling elements 32, 33, respectively, are assembled onto the outer ring raceway surfaces 21, 22, respectively, of the outer ring member 20. Specifically, as shown in FIG. 13, the cage 35 for use on the outer ring raceway surface 22 is inserted through the inner hole of the fitting tubular portion 26 with the rolling elements 33 fitted and held in the respective pockets of the cage 35 and with the cage 35 deformed spirally so as to reduce its diameter (to a diameter smaller than the bore diameter B of the fitting tubular portion 26). Then, the cage 35 is restored to its initial shape, allowing the rolling elements 33 and the cage 35 to be arranged on the outer ring raceway surface 22 positioned on the inboard side. Meanwhile, since the bore diameter E of an outboard portion of the outer ring member 20 is set to be the same as or larger than the circumscribed circle diameter C of the rolling elements 32 (33), an assembly in which the rolling elements 32 have been fitted in the respective pockets of the cage 34 for use on the outboard side is inserted from the opening on the outboard side of the outer ring member 20 to be assembled onto the outer ring raceway surface 21 positioned on the outboard side of the outer ring member 20. With the rolling elements 32, 33 and the cages 34, 35 assembled to the outer ring member 20 in this way, the third embodiment assumes the same state as shown in FIG. 4 showing the first embodiment.

Then, in the same manner as in FIG. 5 showing the first embodiment, the hub spindle 13 of the inner ring member 10 is fittingly inserted into the outer ring member 20. Here, the inner ring element 17 is press-fitted onto the small-diameter shaft portion 15 of the hub spindle 13. Then, in the same manner as in FIG. 6 showing the first embodiment, the tubular portion 16a provided at the tip of the small-diameter shaft portion 15 is calked using a calking jig to form the calked portion 16, allowing the outer ring member 20 and the inner ring member 10 to be integrated with the plurality of lines of roller bearings 30 interposed therebetween. Then, in the same manner as in FIG. 1 showing the first embodiment, the tubular member 60 having the pulser ring 63 is press-fitted onto the outer peripheral surface of the inner ring element 17 of the hub spindle 13 for fixation, and finally the cover member 40 having the rotation detector 50 is press-fitted into the inner peripheral surface of the fitting tubular portion 26 of the outer ring member 20 for fixation. A unitized rolling bearing assembly for a wheel is thus constructed.

As described above, the cage 35 for use on the outer ring raceway surface 22 positioned on the inboard side is formed to be deformable elastically and spirally so as to reduce its diameter. Thus, an assembly in which the rolling elements 33 have been fitted and held in the respective pockets of the cage 35 can be inserted through the inner hole of the fitting tubular portion 26 of the outer ring member 20, allowing the plurality of rolling elements 33 and the cage 35 to be assembled onto the outer ring raceway surface 22 positioned on the inboard side of the outer ring member 20. Thus, the circumscribed circle diameter C of the rolling elements 33 (32) (the maximum diameter of the outer ring raceway surfaces 21, 22) can be set to be larger than the bore diameter B of the fitting tubular portion 26 of the outer ring member 20. Then, the number of the rolling elements 33 (32) used can be increased or the diameter of the rolling elements 33 (32) can be increased for the circumscribed circle diameter C of the rolling elements 33 (32), which is increased compared to the bore diameter B of the fitting tubular portion 26. This increases the rigidity and improves the durability of the rolling bearing assembly for a wheel. In addition, the configuration also provides a weight reduction effect, because the weight of the outer ring member 20 can be reduced for the increase in the circumscribed circle diameter C of the rolling elements 33 (32).

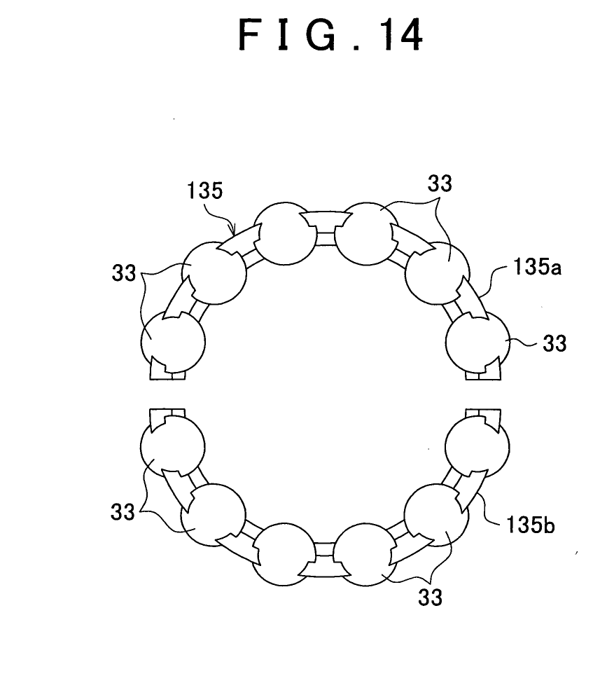

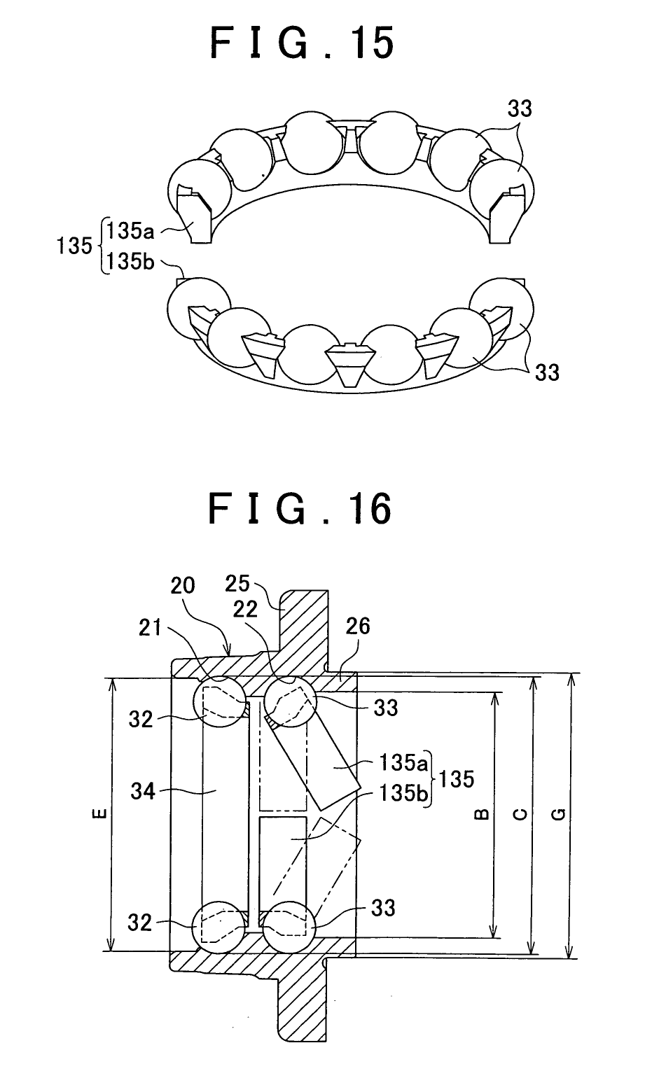

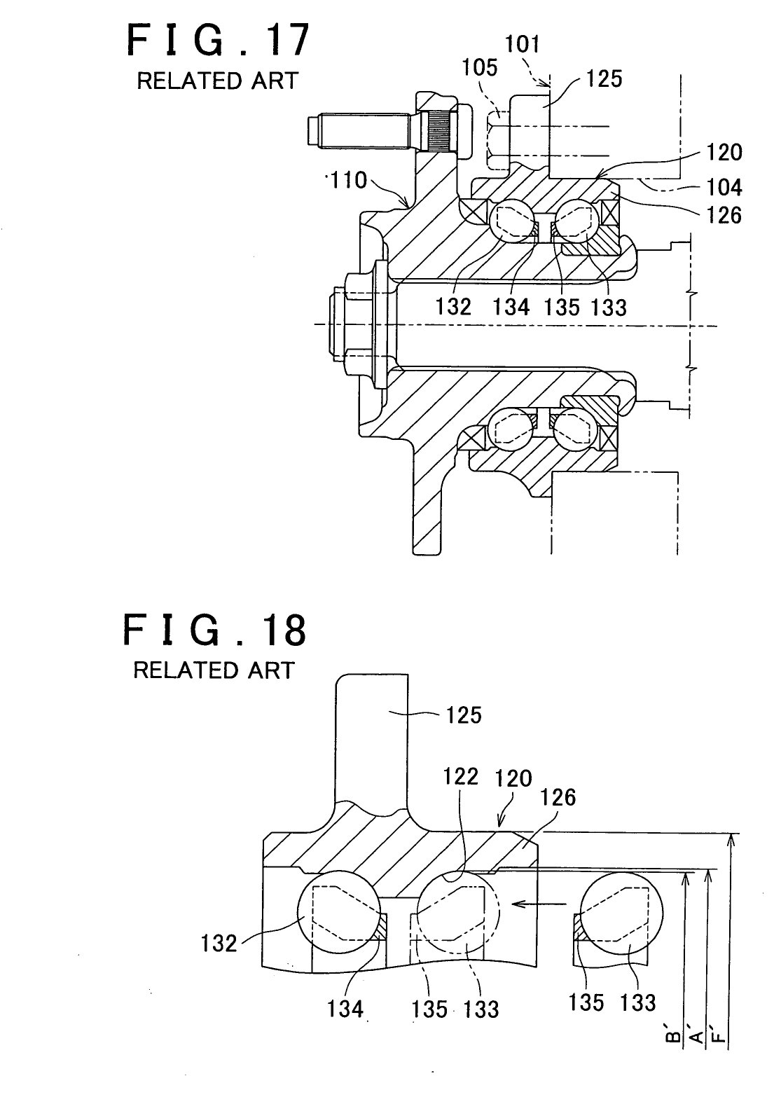

(Fourth Embodiment) A fourth embodiment of the present invention will be described with reference to FIGS. 14 to 16. FIG. 14 is a front view showing a plurality of split cages that constructs a cage of a rolling bearing assembly for a vehicle in accordance with a fourth embodiment of the present invention. FIG. 15 is a perspective view showing the plurality of split cages for use in the fourth embodiment. FIG. 16 is an illustration of the fourth embodiment showing the state in which the plurality of split cages are assembled onto an outer ring raceway surface positioned on the inboard side of the outer ring member.

As shown in FIGS. 14 and 15, in the fourth embodiment, a cage 135 is formed by split cages 135a, 135b that are split into a plurality of (two, in the drawings) pieces in the circumferential direction. Also in the fourth embodiment, as in the third embodiment, in order to increase the rigidity of the rolling bearing assembly for a wheel, the circumscribed circle diameter C of the rolling elements 33 (32) is set to be larger than the bore diameter B of the fitting tubular portion 26 of the outer ring member 20. The configuration of the fourth embodiment is similar to that of the third embodiment in other respects, and thus the same components are denoted by the same reference numerals to omit their descriptions.

Thus, in the fourth embodiment, in assembling the rolling elements 33 and the cage 35 onto the outer ring raceway surface 22 positioned on the inboard side of the outer ring member 20, the rolling elements 33 can be fitted into the respective pockets of both the split cages 135a, 135b, and then as shown in FIG. 16, both the split cages 135a, 135b are sequentially inserted through the inner hole of the fitting tubular portion 26 of the outer ring member 20 so that the plurality of rolling elements 33 and both the split cages 135a, 135b can be assembled onto the outer ring raceway surface 22 positioned on the inboard side of the outer ring member 20. Since the plurality of rolling elements 33 and both the split cages 135a, 135b can be assembled onto the outer ring raceway surface 22 positioned on the inboard side of the outer ring member 20 in this way also in the fourth embodiment, as in the third embodiment, the circumscribed circle diameter C of the rolling elements 33 (the maximum diameter of the outer ring raceway surface) can be set to be larger than the bore diameter B of the fitting tubular portion 26 of the outer ring member 20.

After assembling the plurality of rolling elements 33 and both the split cages 135a, 135b onto the outer ring raceway surface 22 positioned on the inboard side of the outer ring member 20, as in the third embodiment and as shown in FIGS. 5 and 6, the hub spindle 13 of the inner ring member 10 is fittingly inserted into the outer ring member 20, the inner ring element 17 is press-fitted onto the small-diameter shaft portion 15 of the hub spindle 13, and then the tubular portion 16a provided at the tip of the small-diameter shaft portion 15 is calked using a calking jig to form the calked portion 16, allowing the outer ring member 20 and the inner ring member 10 to be integrated with the plurality of lines of roller bearings 30 interposed therebetween. Then, the tubular member 60 having the pulser ring 63 is press-fitted onto the outer peripheral surface of the inner ring element 17 of the hub spindle 13 for fixation, and finally the cover member 40 having the rotation detector 50 is press-fitted into the inner peripheral surface of the fitting tubular portion 26 of the outer ring member 20 for fixation (see FIG. 1).

The present invention is not limited to the embodiments described above, and may be modified in various ways without departing from the spirit and scope of the present invention. For example, although the rolling bearing assembly for a wheel is used for a driven wheel in the embodiments described above, the rolling bearing assembly for a wheel may also be used for a driving wheel.

What is claimed is:

1. A rolling bearing assembly for a wheel, comprising:
an inner ring member that is attached to a wheel, wherein an inner ring raceway surface is formed on an outer peripheral surface of the inner ring member;
an outer ring member having a fitting tubular portion at an inboard end portion of the outer ring member, wherein the fitting tubular portion is fitted into an attachment hole of a vehicle body member, and wherein an outer ring raceway surface is formed on an inner peripheral surface of the outer ring member;
a plurality of rolling elements disposed between both the inner and outer ring raceway surfaces; and
a cage that holds the plurality of rolling elements,
wherein a bore diameter B of the fitting tubular portion of the outer ring member is smaller than a circumscribed circle diameter C of the rolling elements.

2. The rolling bearing assembly for a wheel according to claim 1, wherein
a maximum outer diameter D of the cage is less than or equal to a bore diameter F of an outer ring shoulder portion that is formed on an outboard side of the outer ring member with respect to the outer ring raceway surface, and that projects radially inward, and
the cage is inserted through the outer ring shoulder portion into the outer ring member from the outboard side of the vehicle, with the plurality of rolling elements arranged at regular intervals on the outer ring raceway surface, so that the rolling element is fitted into each pocket of a plurality of pockets of the cage.

3. The rolling bearing assembly for a wheel according to claim 1, wherein
a maximum outer diameter D of the cage is smaller than or equal to the bore diameter B of the fitting tubular portion, and
the cage is inserted into the outer ring member from the inboard side of the vehicle, with the plurality of rolling elements arranged on the outer ring raceway surface, so that the rolling element is fitted into each pocket of a plurality of pockets of the cage.

4. The rolling bearing assembly for a wheel according to claim 1, wherein
the cage is formed with a split portion by which the cage is elastically deformed to reduce its diameter, and
the cage and the plurality of rolling elements are inserted through the fitting tubular portion of the outer ring member, with rolling element fitted into each pocket of a plurality of pockets of the cage, and when the cage is deformed by the split portion to reduce its diameter, and the initial shape of the cage is then restored so that the plurality of rolling elements are arranged on the outer ring raceway surface of the outer ring member.

5. The rolling bearing assembly for a wheel according to claim 1, wherein
the cage is formed by a plurality of split cages that are split in a circumferential direction, and
the split cages are sequentially inserted through the fitting tubular portion of the outer ring member, with rolling element fitted into each pocket of a plurality of pockets of the split cages, so that the plurality of rolling elements are arranged on the outer ring raceway surface of the outer ring member.

6. The rolling bearing assembly for a wheel according to claim 1, wherein
the outer ring raceway surface is formed as a recess with a semicircular cross section in the inner peripheral surface of the outer ring member.

7. A method of manufacturing a wheel rolling bearing assembly, comprising:
preparing an inner ring member that is attached to a wheel, wherein an inner ring raceway surface is formed on an outer peripheral surface of the inner ring member;
preparing an outer ring member having a fitting tubular portion at an inboard end portion of the outer ring member, wherein the fitting tubular portion is fitted into an attachment hole of a vehicle body member, wherein an outer ring raceway surface is formed on an inner peripheral surface of the outer ring member, and wherein the outer ring raceway surface is formed by such a recess that a bore diameter B of the fitting tubular portion of the outer ring member is smaller than a circumscribed circle diameter C of a rolling elements;
preparing the plurality of rolling elements disposed between both the inner and outer ring raceway surfaces;
preparing a cage that holds the plurality of rolling elements;
assembling the plurality of rolling elements and the cage into the recess;
inserting the inner ring member into the outer ring member, to which the plurality of rolling elements and the cage have been assembled; and
calking an inboard end portion of the inserted inner ring member to fix the outer ring member and the inner ring member.

8. The method according to claim 7, wherein the outer ring member has an outer ring shoulder portion that is formed on an outboard side of the outer ring member with respect to the outer ring raceway surface, and that projects radially inward, wherein a maximum outer diameter D of the cage is less than or equal to a bore diameter F of the outer ring shoulder portion, and the method further comprising:
holding the plurality of rolling elements at regular intervals on the outer ring raceway surface;
inserting the cage through the outer ring shoulder portion into the outer ring member from the outboard side of the vehicle; and
fitting rolling element into each pocket of a plurality of pockets of the cage.

9. The method according to claim 7, wherein the fitting tubular portion of the outer ring member is formed such that a maximum outer diameter D of the cage is less than or equal to the bore diameter B of the fitting tubular portion, and the method further comprising:
holding the plurality of rolling elements such that the plurality of rolling elements is arranged on the outer ring raceway surface of the outer ring member;
inserting the cage into the outer ring member from the inboard side of the vehicle; and
fitting rolling element into each pocket of a plurality of pockets of the cage.

10. The method according to claim 7, wherein the cage is formed with a split portion by which the cage is elastically deformed to reduce its diameter, and the method further comprising:
fitting rolling element into each pocket of a plurality of pockets of the cage;
deforming the cage to reduce its diameter by the split portion;
inserting the cage and the plurality of rolling elements through the fitting tubular portion; and
restoring the cage to its initial shape after insertion through the the fitting tubular portion so that the plurality of rolling elements are arranged on the outer ring raceway surface of the outer ring member.

11. The method according to claim 7, wherein the cage includes a plurality of split cages that are split in a circumferential direction, and the method further comprising:
fitting rolling element into each pocket of a plurality of pockets of the split cages; and
sequentially inserting the split cages through the fitting tubular portion, with the plurality of rolling elements fitted in the split cages, so that the plurality of rolling elements are arranged on the outer ring raceway surface of the outer ring member.
